(19) United States
(12) Patent Application Publication
(10) Pub. No.: US 2015/0119502 A1
(43) Pub. Date: Apr. 30, 2015

(54) WOOD PLASTIC COMPOSITES AND MANUFACTURING METHOD THEREOF

(71) Applicant: LG HAUSYS, LTD., Seoul (KR)

(72) Inventors: Kyung Gu Nam, Daejeon (KR); Jong Il Son, Yongin-si (KR)

(21) Appl. No.: 14/389,623

(22) PCT Filed: Apr. 1, 2013
(86) PCT No.: PCT/KR2013/002676

§ 371 Date: Sep. 30, 2014

(30) Foreign Application Priority Data
Apr. 3, 2012 (KR) 10-2012-0034463

(51) Int. Cl. C08L 97/02; C08L 23/12; C08L 27/06; C08L 55/02; B29C 43/00; C08L 33/12; C08L 69/00; B29C 47/00; B29C 45/00; C08L 23/06; C08L 25/06

(52) U.S. Cl. CPC C08L 97/02; C08L 23/06; C08L 23/12; C08L 27/06; C08L 55/02; C08L 25/06; C08L 33/12; C08L 69/00; B29C 47/0004; B29C 45/0001; B29C 43/003; B29K 2001/00
USPC 524/14; 524/13; 264/176.1; 264/328.17

(57) ABSTRACT

Disclosed therein are wood plastic composites and a manufacturing method thereof, which can provide a high discoloration resistance by removing lignin from wood flour which is a main material of the wood plastic composites. The method of manufacturing wood plastic composites includes the steps of: removing lignin contained in wood chips through a cooking process of high temperature and pressure; crushing the wood chip from which lignin was removed in order to produce wood flour; putting and mixing polymer resins and additives into the wood flour so as to manufacture mixture of a gel phase; and extrusion-molding, injection-molding or compression-molding the mixture to manufacture wood plastic composites. The wood plastic composites and the manufacturing method thereof can prevent decoloration and after-yellowing even though the wood plastic composites are exposed to UV or moisture for a long time to thereby enhance long-term weather resistance.

### TECHNICAL FIELD

The present invention relates to wood plastic composites, and more particularly, to wood plastic composites and a manufacturing method thereof, which can provide a high discoloration resistance by removing lignin from wood flour which is a main material of the wood plastic composites.

### BACKGROUND ART

In general, wood plastic composites (WPCs) are wood-like products manufactured through the steps of mixing wood flour and plastic so as to have looks and properties similar to natural woods and injection-molding or extrusion-forming the mixture. Such wood plastic composites are on an increasing trend in use at a high rate every year as materials which can replace natural woods. The wood plastic composites are manufactured by mixing various additives or changing the manufacturing method based on the above method of mixing wood flour and plastic.

Moreover, as plastic used in the conventional wood plastic composite manufacturing method, there are polyethylene (PE), polypropylene (PP), polyvinyl chloride (PVC), and others of high density or low density, and as wood flour, products, lumber fragments, and sawdust of recycled woods are generally used.

Furthermore, in the case of the additives added in various ways when the wood plastic composites are manufactured, kinds and amounts of the additives are changed in various ways according to materials and production methods of the wood plastic composites, the end use of products, and so on.

For instance, there are various kinds of additives, such as mixture for accelerating adhesion and dispersion of wood flour and plastic mixture, blocker not to prevent bond of mixture, sunblock and buffer for preventing decrease in performance of products, foaming agent for reducing density of the products, and so on.

However, the wood flour which is the main material for the wood plastic composites contains lignin, and hence, if wood plastic composites formed using the wood flour is exposed to UV or moisture for a long time, it may cause decoloration and after-yellowing. Accordingly, the conventional wood plastic composite manufacturing method has a problem in that it deteriorates long-term weather resistance.

### DISCLOSURE OF INVENTION

### Technical Problem

Accordingly, the present invention has been made in an effort to solve the above-mentioned problems occurring in the prior arts, and it is an object of the present invention to provide wood plastic composites and a manufacturing method thereof, which can provide a high discoloration resistance by removing lignin from wood flour which is a main material of the wood plastic composites.

### Solution to Problem

To achieve the above objects, the present invention provides a method of manufacturing wood plastic composites including the steps of: removing lignin contained in wood chips through a cooking process of high temperature and pressure; crushing the wood chip from which lignin was removed in order to produce wood flour; putting and mixing polymer resins and additives into the wood flour so as to manufacture mixture of a gel phase; and extrusion-molding, injection-molding or compression-molding the mixture to manufacture wood plastic composites.

In this instance, the cooking process comprises the steps of: putting the wood chips and water into a digester at a weight ratio of 1:2.0 to 5.0; adding cooking liquor containing sulfurous acid or sulfuric acid; and cooking the mixture at temperature of 80° C. to 160° C. for 120 minutes to 180 minutes.

Moreover, the wood flour is heated and dried at temperature of 80° C. to 120° C. till the wood flour has a moisture weight gain of 10% by weight to 20% by weight.

Furthermore, the mixture selectively contains wood flour of 10% by weight to 90% by weight, polymer resins (at least one selected from PP, PE, PVC, ABS, PS, PC, and PMMA) of 10% by weight to 50% by weight, bonding agents of 3% by weight to 6% by weight, UV stabilizers of 0.2% by weight to 1% by weight, compatibilizers of 0.1% by weight to 50% by weight, fillers of 1% by weight to 50% by weight, antioxidants of 0.1% by weight to 30% by weight, lubricants of 0.1% by weight to 30% by weight, and pigments of 0.1% by weight to 30% by weight.

Wood plastic composites according to the present invention is manufactured through one of the above-mentioned manufacturing methods.

### Advantageous Effects of Invention

As described above, the wood plastic composites and the manufacturing method thereof according to the present invention can prevent decoloration and after-yellowing even though the wood plastic composites are exposed to UV or moisture for a long time to thereby enhance long-term weather resistance because the wood plastic composites are manufactured using wood flour from which lignin is removed through a cooking process.

### MODE FOR THE INVENTION

Hereinafter, constitution and action of the present invention will be described in detail as follows.

A method of manufacturing wood plastic composites according to the present invention includes the steps of: removing lignin contained in wood chips through a cooking process of high temperature and pressure; crushing the wood chip from which lignin was removed in order to produce wood flour; putting and mixing polymer resins and additives into the wood flour so as to manufacture mixture of a gel phase; and extrusion-molding, injection-molding or compression-molding the mixture to manufacture wood plastic composites.

In this case, the cooking process includes the steps of: putting the wood chips and water into a digester at a weight ratio of 1:2.0 to 5.0; adding cooking liquor containing sulfurous acid or sulfuric acid; and cooking the mixture at temperature of 80° C. to 160° C. for 120 minutes to 180 minutes, so that lignin contained in the wood chips can be removed. After the cooking process, the wood chips passes through a washing process.

After that, wood flour is produced through the crushing process to crush the wood chips from which lignin is removed. Here, preferably, the wood flour is crushed at the size of 50 mesh to 120 mesh. In this instance, if the size of the wood flour is less than 50 mesh, the size of wood flour becomes too big, and hence, it causes deterioration in dimensional stability and modulus of elasticity of the wood plastic composites. On the contrary, if the size of the wood flour is more than 120 mesh, the wood flour is crushed too finely, and hence, it causes agglomeration of the wood flour during the mixing process and makes mixing of the wood flour with polymer resin difficult.

The crushed wood flour is put into a drier and heated at temperature of 80° C. to 120° C., and then, is dried till the wood flour has a moisture weight gain of 10% by weight to 20% by weight. In other words, if a drying temperature of the wood flour is below 80° C., it takes much time to dry the wood flour. On the contrary, if the drying temperature is above 120° C., the wood flour may be deformed because compact tissues of the wood flour are distorted due to a sudden drying.

Additionally, in the present invention, the wood flour is dried till the wood flour has a moisture weight gain of 10% by weight to 20% by weight, and the reason is that the wood flour is mixed with PP resin or PE resin without adding any binder so as to obtain a sterilizing effect. Accordingly, wood plastic composites can be easily manufactured. On the contrary, if the moisture weight gain is more than 20% by weight, bubbles are created due to evaporation of moisture inside the wood flour when the wood plastic composites are manufactured. It weakens binding force when the wood flour is mixed with polymer resin, and hence, it produces defective products during the wood plastic composite manufacturing process.

The dried wood flour is mixed with polymer resins and additives, and then, the mixture is injection-molded or extrusion-molded. Here, it is preferable that the mixture selectively contains wood flour of 10% by weight to 90% by weight, polymer resins (at least one selected from PP, PE, PVC, ABS, PS, PC, and PMMA) of 10% by weight to 50% by weight, bonding agents of 3% by weight to 6% by weight, UV stabilizers of 0.2% by weight to 1% by weight, compatibilizers of 0.1% by weight to 50% by weight, fillers of 1% by weight to 50% by weight, antioxidants of 0.1% by weight to 30% by weight, lubricants of 0.1% by weight to 30% by weight, and pigments of 0.1% by weight to 30% by weight. The ingredients of the mixture are respectively put into a mixer and mixed for a predetermined period of time to make the mixture.

In this instance, wood flour obtained from a needle leaf tree with compact fibrous tissues is mixed to the mixture at a weight ratio from 10% by weight to 90% by weight, preferably, 40% by weight to 80% by weight, more preferably, 50% by weight to 70% by weight, so as to obtain intrinsic pattern and texture of wood. Moreover, the polymer resins are mixed with the wood flour at a weight ratio from 10% by weight to 50% by weight, preferably, 20% by weight to 50% by weight, more preferably, 30% by weight to 50% by weight, so as to obtain intrinsic features of polymer resins which provide excellent chemical resistance, which are not easily corroded, and which are not degraded in properties due to direct rays of the sun.

Furthermore, the bonding agents of 3% by weight to 6% by weight are added so as to enhance a bonding force between the wood flour and the polymer resins. For your reference, the wood flour has polar nature of hydrophilic property but the polymer resins have non-polar nature of hydrophobic property, and hence, the binding force of the two materials is weak. Therefore, when the bonding agents are added, interaction between the wood flour and the polymer resins is greatly improved due to a new chemical bonding on the interface between the two materials. One of the widest known bonding agents is MAPP (maleated poly-propylene).

Additionally, the UV stabilizers of 0.2% by weight to 1% by weight are added so as to prevent decomposition of synthetic resin polymer due to an influence of ultraviolet rays when the wood plastic composites are exposed to the outside. Therefore, the wood plastic composites can be used semipermanently without being easily distorted or without being deformed.

In addition, the lubricants of 0.1% by weight to 30% by weight are added so as to provide excellent formability of the wood plastic composites extruded in an extruder to thereby reduce a failure rate when the wood plastic composites are extruded.

The wood plastic composites manufactured through the above processes can be used for exterior wall materials of buildings, fence materials or terrace materials of roofs or houses, flooring materials of trails, and so on.

While the present invention has been particularly shown and described with reference to the exemplary embodiment thereof, it will be understood by those of ordinary skill in the art that the technical and protective scope of the present invention shall not be limited to the exemplary embodiment and various changes and modifications may be made therein without departing from the technical idea of the present invention.

1. A method of manufacturing wood plastic composites comprising the steps of:
removing lignin contained in wood chips through a cooking process of high temperature and pressure;
crushing the wood chip from which lignin was removed in order to produce wood flour;
putting and mixing polymer resins and additives into the wood flour so as to manufacture mixture of a gel phase; and
extrusion-molding, injection-molding or compression-molding the mixture to manufacture wood plastic composites.

2. The method of manufacturing wood plastic composites according to claim 1, wherein the cooking process comprises the steps of: putting the wood chips and water into a digester at a weight ratio of 1:2.0 to 5.0; adding cooking liquor containing sulfurous acid or sulfuric acid; and
cooking the mixture at temperature of 80° C. to 160° C. for 120 minutes to 180 minutes.

3. The method of manufacturing wood plastic composites according to claim 1, wherein the wood flour is heated and dried at temperature of 80° C. to 120° C. till the wood flour has a moisture weight gain of 10% by weight to 20% by weight.

4. The method of manufacturing wood plastic composites according to claim 1, wherein the mixture selectively contains wood flour of 10% by weight to 90% by weight, polymer resins (at least one selected from PP, PE, PVC, ABS, PS, PC, and PMMA) of 10% by weight to 50% by weight, bonding agents of 3% by weight to 6% by weight, UV stabilizers of 0.2% by weight to 1% by weight, compatibilizers of 0.1% by weight to 50% by weight, fillers of 1% by weight to 50% by weight, antioxidants of 0.1% by weight to 30% by weight, lubricants of 0.1% by weight to 30% by weight, and pigments of 0.1% by weight to 30% by weight.

5. Wood plastic composites manufactured through the manufacturing method according to claim 1.

6. Wood plastic composites manufactured through the manufacturing method according to claim 2.

7. Wood plastic composites manufactured through the manufacturing method according to claim 3.

8. Wood plastic composites manufactured through the manufacturing method according to claim 4.
